(19) United States
(12) Patent Application Publication
(10) Pub. No.: US 2013/0300146 A1
(43) Pub. Date: Nov. 14, 2013

(54) AUTOMOBILE WINDOW GLASS

(71) Applicant: Asahi Glass Company, Limited, Tokyo (JP)

(72) Inventors: Masanobu Ogawa, Tokyo (JP); Junzo Ooe, Aichi (JP); Takuma Sawaya, Aichi (JP); Takashi Kitagawa, Aichi (JP)

(21) Appl. No.: 13/941,368

(22) Filed: Jul. 12, 2013

Related U.S. Application Data
(63) Continuation of application No. PCT/JP2012/050378, filed on Jan. 11, 2012.

(30) Foreign Application Priority Data
Jan. 14, 2011 (JP) 2011-006020

(51) Int. Cl. B60J 1/02; E06B 5/18

(52) U.S. Cl. CPC B60J 1/02; E06B 5/18
USPC 296/84.1

(57) ABSTRACT

The present invention relates to a window glass for a vehicle, including: an electromagnetic wave transmitting portion which transmits a predetermined electromagnetic wave, and is positioned above a position where a rearview mirror provided at a front and upper portion inside of the vehicle is projected on the window glass for a vehicle in a longitudinal direction and a horizontal direction of the vehicle, in which a distance in a width direction of the electromagnetic wave transmitting portion is larger than a width which is projected in a horizontal direction on the window glass for a vehicle at 45 degree angle towards each of both sides in a width direction from a central portion in a width direction of the rearview mirror relative to a longitudinal direction of the vehicle.

### TECHNICAL FIELD

The present invention relates to a window glass for a vehicle and more particularly to a window glass for a vehicle having an infrared ray shielding performance.

### BACKGROUND OF THE INVENTION

In recent years, there is an increasing tendency to use a glass having an infrared ray shielding performance (hereinafter, referred to as an infrared ray shielding glass from time to time) for a window glass for a vehicle with a view to suppressing the increase in temperature inside a vehicle and reducing the cooling load. Conventionally, a film-laminated glass sheet is used for an infrared ray shielding glass on the surface of which a conductive thin film of various types of metal or metal oxides is laminated, and solar radiation energy entering the inside a vehicle is largely cut off by the function of these films.

In Japan, in these years, VICS (registered trademark) (Vehicle Information and Communication System) employing optical beacons is prevailing. This is a system for preventing the occurrence of traffic jams on roads by informing vehicles of traffic information collected at information centers and informing the information centers of information on the side of vehicles. Specifically, bilateral electromagnetic wave communications are implemented between devices set on roads (hereinafter, referred to as roadside antennas) and devices set inside vehicles (hereinafter, referred to as on-board devices).

Further, as systems employing infrared rays, keyless entry system and garage door openers are also prevailing. The keyless entry system and the garage door openers are a system in which an infrared signal is sent from a transmitter inside a vehicle to a receiver on a garage to thereby unlock or open the door of the garage.

Thus, in order to cause these systems to operate properly, the window glass needs to have an electromagnetic wave transmitting performance.

In a window glass for a vehicle described in Patent Document 1, a transmitter/receiver is attached directly to part of a window glass on an inner side of a vehicle, and an infrared ray shielding layer is not provided only in the position where the transmitter/receiver is attached, whereby an electromagnetic wave communication is permitted between an exterior of the vehicle and the transmitter/receiver while cutting off solar radiation energy.

### BACKGROUND ART

### Patent Document

Patent Document 1: JP-A-8-210042

### SUMMARY OF THE INVENTION

Problems that the Invention is to Solve

Incidentally, in addition to a VICS, a garage door opener, and a remote keyless entry system, on-board devices such as a GPS antenna, an ETC antenna, a tire air pressure sensor and the like are also incorporated in a rearview mirror of a vehicle from time to time. Although it is effective to the transmitter/receiver which is attached directly to the window glass, the window glass for a vehicle described in Patent Document 1 cannot deal properly with a transmitter/receiver which is disposed away from the window glass, and therefore, there are concerns that a problem is caused in a proper operation of such an son-board device incorporated in the rearview mirror.

Then, an object of the invention is to provide a window glass for a vehicle that enables an electromagnetic wave communication by an on-board device incorporated in a rearview mirror and which has an infrared ray shielding performance.

### Means for Solving the Problems

According to the invention, the following embodiment will be provided.

(1) A window glass for a vehicle attached to a body flange of a front side of the vehicle at a circumferential portion thereof, comprising: an infrared ray shielding portion which reflects or absorbs infrared rays on a large part of the window, and an electromagnetic wave transmitting portion which transmits a predetermined electromagnetic wave, and is positioned above a position where a rearview mirror provided at a front and upper portion inside of the vehicle is projected on the window glass for a vehicle in a longitudinal direction and a horizontal direction of the vehicle, wherein a distance in a width direction of the electromagnetic wave transmitting portion is larger than a width which is projected in a horizontal direction on the window glass for a vehicle at 45 degree angle towards each of both sides in a width direction from a central portion in a width direction of the rearview mirror relative to a longitudinal direction of the vehicle,

(2) The window glass for a vehicle according to (1), wherein a lower edge of the electromagnetic wave transmitting portion is spaced 150 mm or more from a tip portion of the body flange which is positioned at upper side thereof.

(3) The window glass for a vehicle according to (1) or (2), wherein the infrared ray shielding portion is situated inwards of the tip portion of the body flange, and the electromagnetic wave transmitting portion is provided so that an upper end portion of the infrared ray shielding portion recedes into inwards thereof.

(4) The window glass for a vehicle according to any one of (1) to (3), wherein the distance in a width direction of the electromagnetic wave transmitting portion is larger than a width which is projected in a horizontal direction on the window glass for a vehicle at 60 degree angle towards each of both sides in a width direction from a central portion in a width direction of the rearview mirror relative to a longitudinal direction of the vehicle.

(5) The window glass for a vehicle according to any one of (1) to (4), wherein the electromagnetic wave transmitting portion is a frequency selective surface in which a thermal wave reflecting film is formed in a mesh-shape.

### Advantage of the Invention

According to the invention, the infrared ray shielding portion can suppress the increase in temperature inside the vehicle and reduce the cooling load by reflecting or absorbing infrared rays by the infrared ray shielding portion. In addition, since the electromagnetic wave transmitting portion is provided above the position on the window glass for a vehicle where the rearview mirror inside the vehicle is projected, and the width of the electromagnetic wave transmitting portion is larger than the width which is projected in a horizontal direction on the window glass for a vehicle at 45 degree angle towards each of both sides in a width direction from a central portion in width direction of the rearview mirror relative to a longitudinal direction of the vehicle, the electromagnetic wave communication by the on-board device incorporated in the rearview mirror can be performed well.

### BRIEF DESCRIPTION OF THE DRAWINGS

FIG. 1 is a front view of a window glass for a vehicle according to one embodiment of the invention.

FIG. 2 is a partial sectional view of the window glass for a vehicle shown in FIG. 1.

FIG. 3(a) is a overhead view of the window glass for a vehicle shown in FIG. 1, and FIG. 3(b) is a side view of the window glass for a vehicle shown in FIG. 1.

FIG. 4 is a graph showing a relation between an opening angle of an electromagnetic wave transmitting portion and a communication distance.

### MODE FOR CARRYING OUT THE INVENTION

Next, an embodiment of the invention will be described.

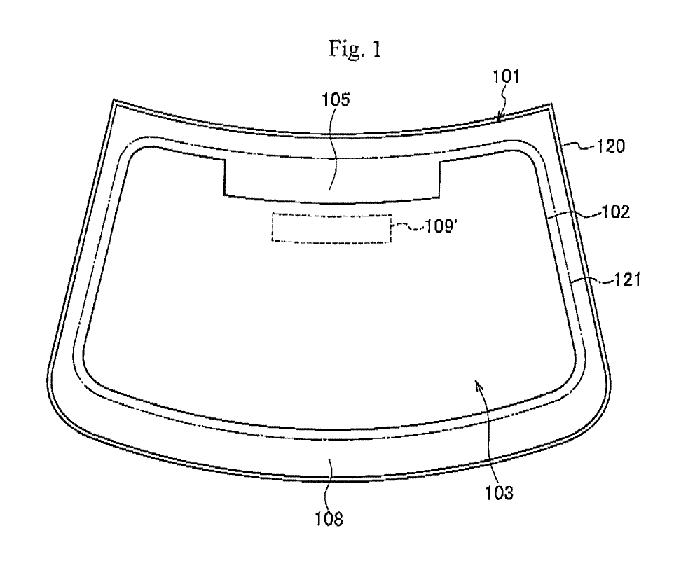

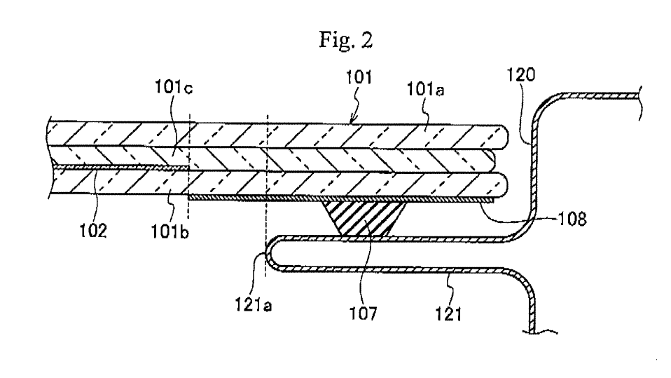

FIG. 1 is a front view of a window glass for a vehicle according to one embodiment of the invention. A window glass for a vehicle 101 of this embodiment is a so-called laminated glass and is used as a windshield which is fitted in a substantially rectangular opening portion 120 in a body of a vehicle. The window glass for a vehicle 101 is bonded and fixed to a body flange 121 which projects inwards from the opening portion 120 for the windshield via an adhesive 107 (refer to FIG. 2).

As shown in FIG. 2, the window glass for a vehicle 101 is a laminated glass in which an intermediate film 101c of transparent resin such as PVB (Polyvinyl Butyral) or the like is sandwiched by a glass sheet which is positioned on an outer side of the vehicle (an outer sheet 101a) and a glass sheet which is positioned on an inner side of the vehicle (an inner sheet 101b) therebetween. A black ceramic layer 108, which is formed by being screen printed and then fired, is provided on an inner side surface of a circumferential edge of the inner sheet 101b so as to extend along the full circumference of the window glass for a vehicle 101 in a substantially frame-shape. The black ceramic layer 108 is a black or dark-colored ceramic film and can prevents the transmission of not only visible light but also ultraviolet rays, thereby making it possible to prevent the deterioration of the adhesive 107 by ultraviolet rays. In addition, the adhesive 107 becomes invisible from the outside of the window glass for a vehicle 101, thereby increasing the aesthetic properties of an external appearance thereof. It should be noted that the black ceramic layer 108 may be provided either on an inner side surface of the outer sheet 101a or an outer side surface of the inner sheet 101b.

A conductive film 102 is provided on an outer side surface of the inner sheet 101b in the form of a film or a coating. This conductive film 102 is cut back inwards on the order of several centimeters from an outer circumferential edge portion of the inner sheet 101b along a full circumference thereof, and the area where the conductive film 102 is formed constitutes an infrared ray shielding portion 103 having an infrared ray shielding performance. In this embodiment, this cut-back amount is set so that the conductive film 102 lies inwards of the opening portion 120 along a full circumference thereof in such a way that the conductive film 102 does not overlap the body flange 121 which forms the opening portion 120, that is, the conductive film 102 is offset from the body flange 121 with the window glass for a vehicle 101 fitted in the opening portion 120. In addition, in this embodiment, although not particularly limited thereto, an edge portion of the conductive film 102 is set so as to substantially coincide with a tip portion 121a of the body flange 121 excluding a position where an electromagnetic wave transmitting portion 105, which will be described later, is formed. By setting so, the infrared shielding area 103 can be made as small as possible while maintaining the infrared ray shielding effect as it is.

Additionally, the conductive film 102 may be provided on the inner side surface of the outer sheet 101a or the intermediate film 101c in the form of a film or a coating or may be provided by sandwiching a conductive film between two intermediate films.

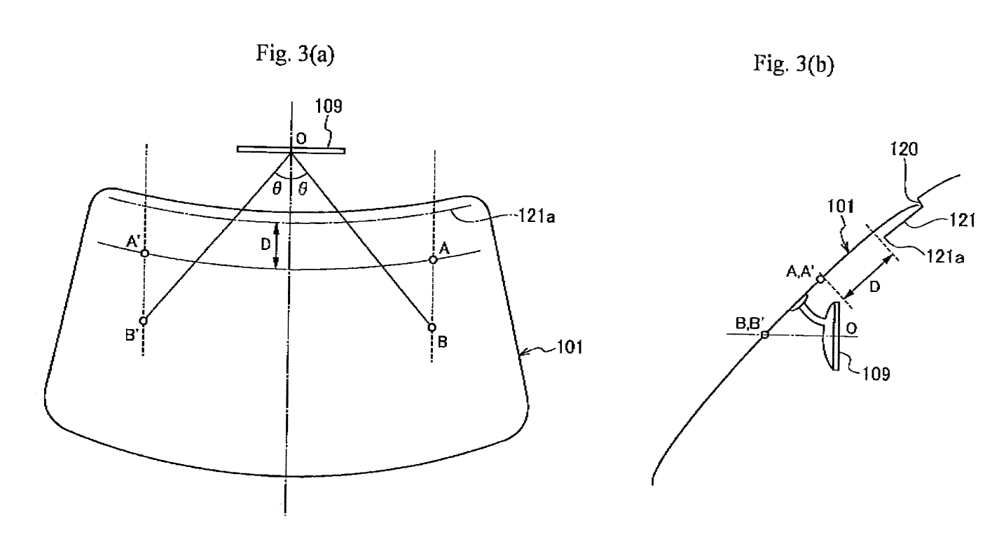

In addition, as shown in FIGS. 3(a) and 3(b), a rearview mirror 109 is provided at a front and upper portion inside the vehicle. The rearview mirror 109 is placed on the windshield via a support member using an adhesive. The invention is not limited thereto, and hence, the rearview mirror 109 may be placed in a position above the windshield and near a ceiling inside the vehicle. As an example, an infrared transmitter of a garage door opener (hereinafter, also referred to as an on-board device) is incorporated in the rearview mirror 109. When manually operated by an occupant, this on-board device sends an infrared ray to an infrared receiver provide on a garage door so as to open or close the garage door. Incidentally, it should be noted that the on-board device may be any device as long as it can perform an electromagnetic wave communication with an external device, not shown, and hence, the on-board device may be a receiver which only receives an electromagnetic wave, a transmitter which only sends an electromagnetic wave or a transmitter and receiver which performs both a sending and a reception of an electromagnetic wave.

Further, an electromagnetic wave transmitting portion 105 adapted to enable an electromagnetic wave communication of an on-board device is provided in the window glass for a vehicle 101 of this embodiment. Incidentally, this electromagnetic wave transmitting portion 105 is provided by not providing the conductive film 102 at a target area. Alternatively, a frequency selective surface (FSS) where a mesh-shape or slit-shape pattern adapted to transmit a predetermined electromagnetic wave is formed may be provided at the target area in the conductive film 102. By not providing the conductive film 102 or by forming the frequency selective surface, predetermined electromagnetic waves including infrared rays can be transmitted through.

As shown in FIG. 1, this electromagnetic wave transmitting portion 105 lies above a position 109′ where the rearview mirror 109 is projected in a longitudinal direction and a horizontal direction of the vehicle on the window glass for a vehicle 101, and a distance in a width direction of the electromagnetic wave transmitting portion is larger than a width of the rearview mirror 109 which is projected in a horizontal direction on the window glass for a vehicle at 45 degree angle (an opening angle θ) towards each of both sides in a width direction from a central portion in a width direction (a left-to-right direction) of the rearview mirror 109 relative to a longitudinal direction of the vehicle on the window glass for a vehicle 101. In particular, the distance in a width direction of the electromagnetic wave transmitting portion is preferably larger than a width of the rearview mirror 109 which is projected in a horizontal direction on the window glass for a vehicle at 60 degree angle towards both sides in the width direction respectively from the central portion in a width direction of the rearview mirror 109 on the window glass for a vehicle 101.

The positioning of this electromagnetic wave transmitting portion 105 will be described more specifically by reverence to FIGS. 3(a) and 3(b). Firstly, imaginary lines are drawn in a width direction at an opening angle θ which is ±45 degree angle with respect to the longitudinal direction of the vehicle from a center of the rearview mirror 109 in a height direction (a vertical direction) and in the width direction thereof, and points where the imaginary lines intersect the window glass for a vehicle 101 are referred to as points of intersection B, B′. Then, boundary points A, A′ which constitute both end portions in a width direction of a lower edge of the electromagnetic wave transmitting portion 105 are determined above the position where the rearview mirror 109 is projected in the longitudinal direction and the horizontal direction of the vehicle from the points of intersection B, B′ along the surface of the window glass for a vehicle 101. Then, the electromagnetic wave transmitting portion 105 is formed so that the boundary points A, A′ become both end portions in the width direction of the lower edge of the electromagnetic wave transmitting portion 105.

A distance D between a lower edge of the electromagnetic wave transmitting portion 105 and the tip portion 121a of the body flange 121 which is positioned at upper side thereof is preferably 150 mm or more. By adopting the configuration in which the lower edge of the electromagnetic wave transmitting portion 105 is disposed in a position which is spaced 150 mm or more away from the tip portion 121a of the body flange 121 along the surface of the window glass for a vehicle 101, electromagnetic waves sent from the inside of the vehicle or received from the outside of the vehicle diffract with the influence of the body flange 121 reduced, and therefore, the transmitting and receiving performance of the on-board device is improved.

In addition, the infrared ray shielding portion 103 is preferably such that a boundary line of the infrared ray shielding portion 103 lies further inwards than the tip portion 121a of the body flange 121 along the surface of the window glass for a vehicle 101 and the electromagnetic wave transmitting portion 105 is formed by causing the boundary line at an upper end portion which is an upper edge of the infrared ray shielding portion 103 to recede into inwards thereof in a recess-shape fashion, Namely, the electromagnetic wave transmitting portion 105 is formed as far as the body flange 121, and electromagnetic waves sent from the inside of the vehicle or received from the outside of the vehicle are allowed to diffract easily, whereby the transmitting and receiving performance of the on-board device is improved.

### EXAMPLES

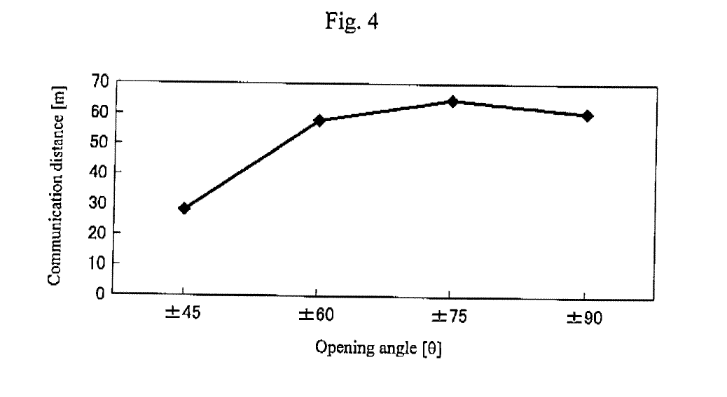

FIG. 4 shows the results of measurements carried out to study about a relation between an opening angle of an electromagnetic wave transmitting portion and a transmitting distance in a garage door opener which is incorporated in a rearview mirror for performing an infrared communication using an infrared ray whose frequency band is 288 MHz. Measurements were made on four types of window glasses including electromagnetic wave transmitting portions having widths resulting horizontally on the window glass for a vehicle 101 when the rearview mirror 109 was projected in a width direction from a center O in a height direction and a width direction thereof at opening angles θ which were ±45 degree angle, ±60 degree angle, ±75 degree angle, ±90 degree angle with respect to a longitudinal direction of the vehicle. In addition, an electromagnetic wave transmitting portion 105 was formed so that a lower edge thereof was positioned above a position on the window glass for a vehicle 101 where the rearview mirror 109 was projected in the longitudinal and horizontal directions of the vehicle, a distance between the lower edge of the electromagnetic wave transmitting portion 105 and a tip portion 121a of a body flange 121 was 150 mm, and a boundary line at an upper end portion of the electromagnetic wave transmitting portion 105 which was an upper edge of an infrared ray shielding portion 103 was caused to recede into inwards thereof in a recess-like shape.

An axis of abscissas in FIG. 4 denotes a horizontal width of the electromagnetic wave transmitting portion which is expressed by an opening angle (°) at which the rearview mirror 109 is projected in a width direction on the window glass for a vehicle 101. An axis of ordinates denotes a communication distance over which a communication is implemented between a garage door opener incorporated in the rearview mirror and a receiver on a garage door. A measuring method of measuring a communication distance was such that a vehicle in which the window glass to be measured was fitted in a window frame at front side of the vehicle was disposed in an electromagnetic wave dark room, and a signal was sent from the garage door opener incorporated in the rearview mirror for measurement while changing the distance between the receiver and the vehicle.

According to FIG. 4, when the opening angle θ is ±45 degree angle, the communication distance is 28.5 m, and when the opening angle θ is larger than ±45 degree angle, the communication distance becomes remarkably long. Consequently, it is seen that the distance in a width direction of the electromagnetic wave transmitting portion 105 that when the opening angle θ is θ>±45 degree angle, the communication distance is improved largely. Preferably, the opening angle θ is θ±60 degree angle, and more preferably, the opening angle θ is 60 degree angle≦θ≦75 degree angle. In addition, although the opening angle θ may be large, the infrared ray shielding performance is deteriorated more as the opening angle θ becomes larger. Therefore, the opening angle θ is preferably 90 degree angle or less. Incidentally, the similar results were also obtained with the garage door opener which communicates using an infrared ray whose frequency band in 390 MHz.

### INDUSTRIAL APPLICABILITY

A window glass for a vehicle 101 of the invention can suppress the increase in temperature inside the vehicle to thereby reduce the cooling load as a result of the infrared ray shielding portion 103 reflecting or absorbing infrared rays. On the other hand, the electromagnetic wave communication can be performed well as a result of transmitting the electromagnetic wave of the on-board device such as the garage door opener incorporated in the rearview mirror 109, in the electromagnetic wave transmitting portion 105.

In addition, since the electromagnetic wave transmitting portion 105 is provided above the position 109 where the rearview mirror 109 is projected, the boundary line with the infrared ray shielding portion does not interrupt the visibility of occupants.

Incidentally, the invention is not limited to the embodiment described heretofore and hence can be modified or improved as required. In addition, although the garage door opener is described as being the example of the on-board device, the invention is not limited thereto. Hence, a GPS antenna, an ETC antenna, a tire air pressure sensor and a remote keyless entry system may be incorporated in the rearview mirror.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2011-006020 filed on Jan. 14, 2011, and the contents are incorporated herein by reference.

### DESCRIPTION OF REFERENCE NUMERALS AND SIGNS

101 Window glass for a vehicle;

101a Outer sheet;

101b Inner sheet;

101c Intermediate film;

102 Conductive film;

103 Infrared ray shielding portion;

105 Electromagnetic wave transmitting portion;

107 Adhesive;

108 Black ceramic layer;

109 Rearview mirror;

109′ Rearview mirror projected position;

120 Opening portion;

121 Body flange;

121a Tip portion.

1. A window glass for a vehicle, attached to a body flange of a front side of the vehicle at a circumferential portion thereof, comprising:
an infrared ray shielding portion which reflects or absorbs infrared rays on a large part of the window, and
an electromagnetic wave transmitting portion which transmits a predetermined electromagnetic wave, and is positioned above a position where a rearview mirror provided at a front and upper portion inside of the vehicle is projected on the window glass for a vehicle in a longitudinal direction and a horizontal direction of the vehicle,
wherein a distance in a width direction of the electromagnetic wave transmitting portion is larger than a width which is projected in a horizontal direction on the window glass for a vehicle at 45 degree angle towards each of both sides in a width direction from a central portion in a width direction of the rearview mirror relative to a longitudinal direction of the vehicle.

2. The window glass for a vehicle according to claim 1, wherein a lower edge of the electromagnetic wave transmitting portion is spaced 150 mm or more from a tip portion of the body flange which is positioned at upper side thereof.

3. The window glass for a vehicle according to claim 1, wherein the infrared ray shielding portion is situated inwards of the tip portion of the body flange, and the electromagnetic wave transmitting portion is provided so that an upper end portion of the infrared ray shielding portion recedes into inwards thereof.

4. The window glass for a vehicle according to claim 1, wherein the distance in a width direction of the electromagnetic wave transmitting portion is larger than a width which is projected in a horizontal direction on the window glass for a vehicle at 60 degree angle towards each of both sides in a width direction from a central portion in a width direction of the rearview mirror relative to a longitudinal direction of the vehicle.

5. The window glass for a vehicle according to claim 1, wherein the electromagnetic wave transmitting portion is a frequency selective surface in which a thermal wave reflecting film is formed in a mesh-shape.
